(19) United States
(12) Patent Application Publication
(10) Pub. No.: US 2009/0276469 A1
(43) Pub. Date: Nov. 5, 2009

(54) METHOD FOR TRANSACTIONAL BEHAVIOR EXTACTION IN DISTRIBUTED APPLICATIONS

(75) Inventors: Dakshi Agrawal, Monsey, NY (US); Chatschik Bisdikian, Chappaqua, NY (US); Seraphin Calo, Cortlandt Manor, NY (US); Hoi Yeung Chan, New Canaan, CT (US); Kang-Won Lee, Nanuet, NY (US); Dinesh Verma, Mount Kisco, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/113,252

(22) Filed: May 1, 2008

(51) Int. Cl. G06F 17/30

(52) U.S. Cl. 707/202; 707/E17.007

(57) ABSTRACT

A method of analyzing log data related to a software application includes: selectively collecting data log entries that are related to the application; agnostically categorizing the data log entries; and associating the categories of the data log entries with one or more operational states of a model.

### BACKGROUND

1. Field

This invention generally relates to methods, systems and computer program products for performing data analysis for distributed applications.

2. Description of Background

Data analysis of computer generated logs enables the management, configuration, monitoring, troubleshooting, and/or administration of enterprise-level computing applications. Analysis of data logs may reveal an operational status of computer applications and systems, can aid in discovering the causes of abnormal operation, can form the basis for forecasting the behavior of an application or system, and can enable the execution of autonomous self-healing operations.

Traditional methods of analyzing these logs utilize highly skilled personnel to manually review the data logs. Other methods of analyzing these logs make use of computing solutions that have been specifically designed and instrumented from the ground-up to facilitate the data log analysis based on strictly defined data structures.

However, many of today's applications have not been developed according to strict end-to-end development standards. This is because the applications may be built by different teams of non-associated developers and may be built at different times to satisfy an organization's evolving needs. An example of such a case pertains to applications that evolve from independently developed application pieces as a result of department, division, or even company-level mergers. Thus, computer-based applications whose end-to-end operation in executing high-level jobs involves a workflow of constituent computing processes executed over a distributed and heterogeneous computing environment are particularly challenging when it comes to analyzing the data logs. These applications are even more challenging when data log analysis is to be performed when neither the workflow of processes involved nor the semantics of the data logs are known to those tasked with the data analysis.

### SUMMARY

The shortcomings of the prior art are overcome and additional advantages are provided through a method of analyzing log data related to a software application includes: selectively collecting data log entries that are related to the application; agnostically categorizing the data log entries; and associating the categories of the data log entries with one or more operational states of a model.

System and computer program products corresponding to the above-summarized methods are also described and claimed herein.

Additional features and advantages are realized through the techniques of the exemplary embodiments described herein. Other embodiments and aspects of the invention are described in detail herein and are considered a part of the claimed invention. For a better understanding of the invention with advantages and features, refer to the detailed description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows an exemplary deployment of a distributed application involving a number of processes, servers, and ancillary computing services, according to an exemplary embodiment;

FIG. 2 illustrates a method for transactional behavior extraction in distributed applications, according to an exemplary embodiment;

FIG. 3 shows an example of a pattern sequence derived from a data log, according to an exemplary embodiment;

FIG. 4 illustrates a method for generating log entry categories agnostically, according to an exemplary embodiment; and

FIG. 5 illustrates a method for correlating log entries agnostically based on the distance between log entries, according to an exemplary embodiment.

The detailed description explains an exemplary embodiment, together with advantages and features, by way of example with reference to the drawings.

### TECHNICAL EFFECTS

As a result of the summarized invention, technically we have achieved a solution which enables data to be analyzed agnostically without the need for dedicating highly skilled, domain expert personnel for the task.

### DETAILED DESCRIPTION

Exemplary embodiments relate to the area of data analysis of log information produced by computing systems in order to derive higher-level conclusions about the operational state of the computing applications executed by these systems.

Exemplary embodiments relate to the analysis of the data logs generated by an application with the objective to learn how the application operates and, hence, to facilitate the subsequent introduction of monitoring capabilities for the application. The analysis may include the development of a model (or a computer executable abstraction) of the workflow of processes that the application visits during its execution of a transaction of the transaction type of interest.

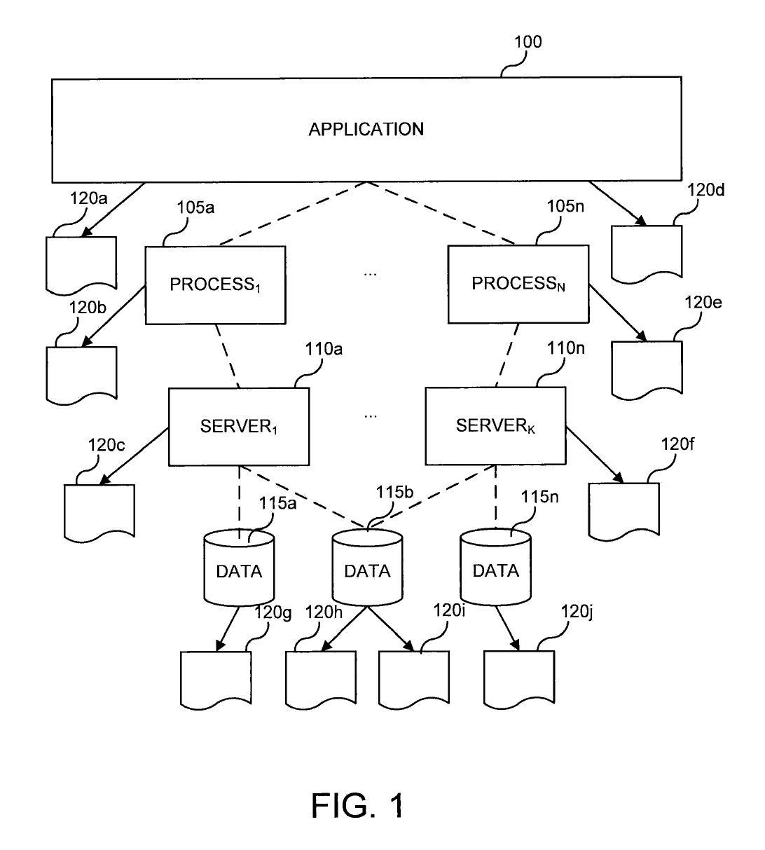

Turning now to the Figures, it should be understood that throughout the drawings, corresponding reference numerals indicate like or corresponding parts and features. FIG. 1 shows an exemplary distributed application 100 that includes a plurality of computers processes 105a-105n executed on a network of server platforms 110a-110n. The application 100 makes use of additional computing services, for example databases 115a-115n. In one example, the application 100 may represent a Java servlet-based web application with the plurality of processes 105a-105n representing servlets that make up the application 100 and are executed on the network of server platforms 110a-110n. The processes 105a-105n and the server platforms 110a-110n may make use of the databases 115a-115n for storing and retrieving data pertinent to the application 100 (and other applications). As can be appreciated, other exemplary applications pertinent to this disclosure may involve more or fewer layers of computing components.

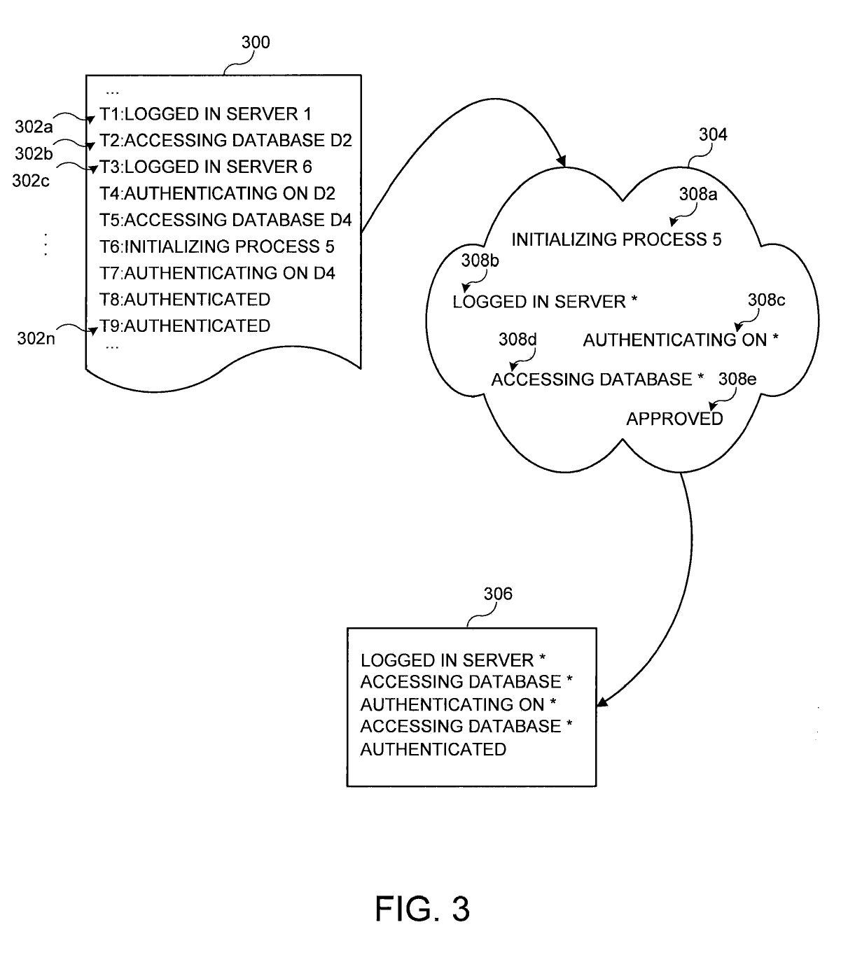

During execution of one or more of the computing components, the exemplary application 100 produces data logs 120a-120j. Each data log 120a-120j includes one or more log entries or records (see, e.g., 302a-302n of FIG. 3). The log entries can include, for example, a timestamp (denoted by T(x) in FIG. 3) message and/or the log record payload. Because multiple applications 100 may share the same processes 105a-105n, servers 110a-110n, and/or databases 115a-115n, the data logs 120a-120j can include log entries or records that are triggered by events other than those related to the execution of the application 100, for example, events triggered by execution of another application (not shown).

In the example of FIG. 1, there is limited or no prior knowledge of any relationships between the execution of the application 100 and any of the log entries. In other words, in an exemplary business environment including the exemplary application 100, the business environment has only limited or no prior understanding of the contents of the logs 120a-120j. Furthermore, if a data log analyst of the business environment looks at any specific log entry in the logs 120a-120j, the analyst cannot make any statement from the outset as to whether the log entry reveals any specific information regarding the operational state of the application 100.

According to exemplary embodiments of the present disclosure, methods, systems, and computer program products are provided that may assist a data log analyst to organize information found in the data logs 120a-120j in order to facilitate the discovery of relationships between the execution state of the application 100 and the logs 120a-120j. This in turn, will facilitate the development of monitoring procedures for the application 100 by making use of the log entries 120a-120j, for example, using the external, visible and recordable behavior of the application 100, rather than the internal and invisible behavior.

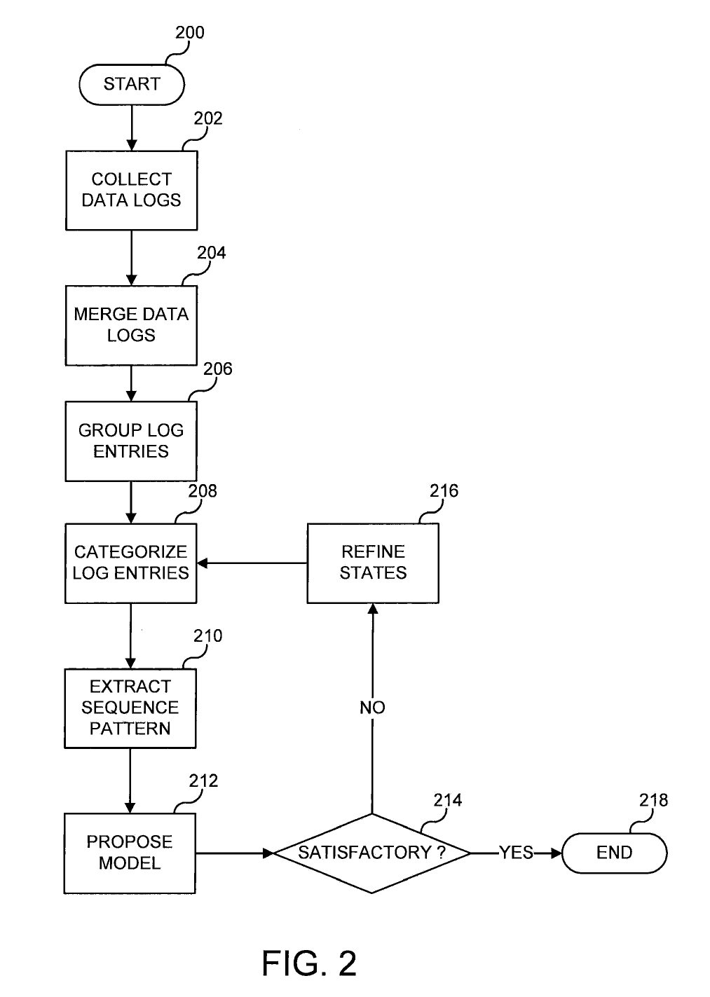

FIG. 2 illustrates an exemplary method for organizing the log information in accordance with an exemplary embodiment. As can be appreciated in light of the disclosure, the order of operation within the method is not limited to the sequential execution as illustrated in FIG. 2, but may be performed in one or more varying orders as applicable and in accordance with the present disclosure. As can be appreciated, the process steps of the method can be implemented as one or more computer program products, components, or modules. As used herein, the term module refers to an Application Specific Circuit (ASIC), an electronic circuit, a processor (shared, dedicated, or group) and/or memory that executes one or more software or firmware programs, a combinational logic circuit, and/or other suitable components that provide the described functionality.

In one example, the method may begin at block 200. The data logs 120a-120j (FIG. 1) are evaluated and any pertinent and/or available data logs are collected at block 202. If more than one pertinent data log is available, the pertinent data logs are merged, creating a single (e.g., virtual) date log (see, e.g., 300 of FIG. 3) at block 204. In one example, the merging can be performed by: selecting a log entry with an earliest (or smallest) timestamp T(x) from the data logs; removing or copying the log entry from the original log and adding it as a next entry (i.e., at the bottom) in the single merged data log. In various embodiments, the timestamps of the log entries can be normalized to a common (numeric) format, in order to perform the timestamp comparisons. Note that the reference to a virtual log is made to illustrate the fact that, in various embodiments, the single merged data log may not be physically created in advance, but may be created on-the-fly by retrieving the next log entry, just prior to that log entry being needed.

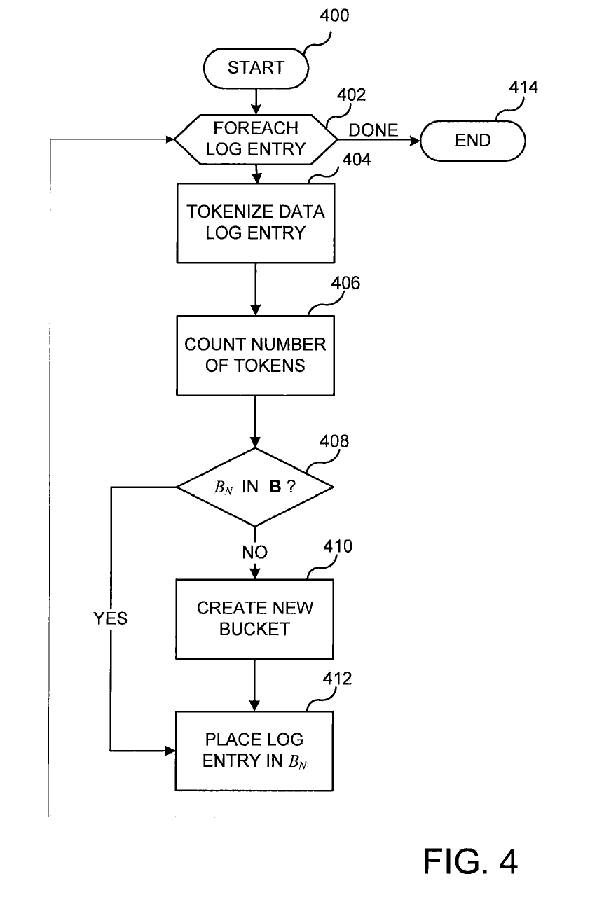

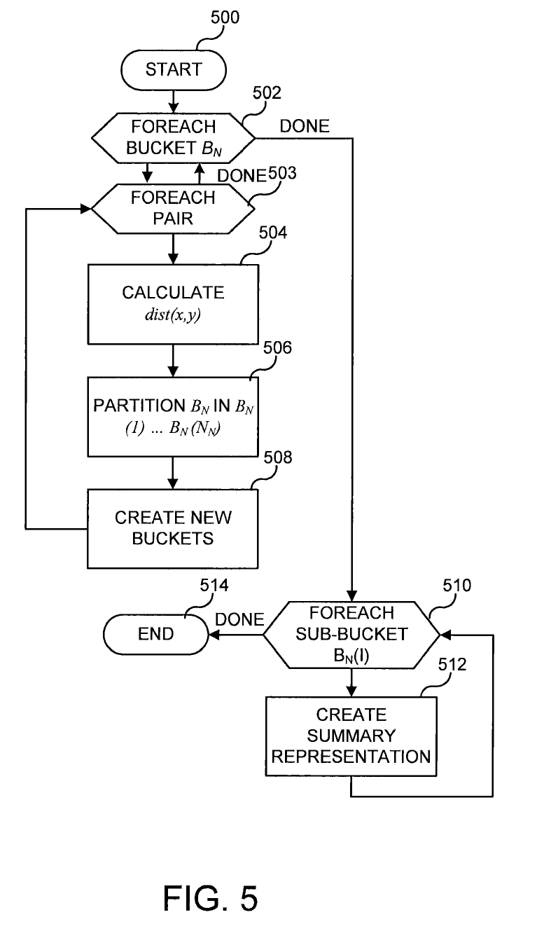

Operating on the merged, single log, the log entries of the merged log are grouped and categorized according to an agnostic method at blocks 206 and 208, for example, a method that does not depend on knowledge or understanding of the semantics of the log entries. An exemplary embodiment of an agnostic grouping method is described herein with reference to FIG. 4. An exemplary embodiment of an agnostic categorization method is described herein with reference to FIG. 5. The outcome of the agnostic categorization is a collection of categories, also referred to as candidate states, (see, e.g. 304 of FIG. 3) representing the log entries.

Based on the candidate states, data log sequence patterns are extracted from the data log entries at block 210. A sequence pattern (see, e.g., 306 at FIG. 3) is a finite sequence of candidate states that appear to repeat themselves. The sequence pattern represents a candidate realization of at least a portion of the workflow model. Additional sequence patterns may also be extracted and statistical means can be used to rank the patterns according to various criteria (e.g., the most probable patterns, the patterns that appear periodically, and so on).

When no further knowledge about the data logs is available, the sequence patterns are used as the basis to create the workflow model at block 212 and then for constructing the necessary monitoring facilities for the application 100. In various embodiments, these patterns can be shared with domain experts who can then provide feedback about the accuracy of the candidate model.

Based on any additional information or feedback available, the proposed model can be deemed satisfactory at block 214 (yes) and the method may end at block 218. However, the proposed model may also be deemed not yet satisfactory at block 214 (no) in which case the model states are further refined at block 216 and the process is repeated at block 208 by re-categorizing the data logs until a sufficiently satisfactory model, based on the information available in the data logs, is produced at block 214. Thereafter, the method may end at block 218.

Turning now to FIG. 3, an exemplary data log 300 and sequence pattern 306 is shown. A segment from an exemplary data log 300 includes one or more time-stamped log entries 302a-302n. The timestamps are represented by the non-decreasing sequence T1, T2, and so on. A collection 304 of categories or candidate states 308a-308c is generated from the log entries 302a-302n (e.g., “authenticating *” and “approved”) which will be discussed in more detail herein with reference to FIG. 5.

For each candidate state 308a-308e, the timestamp is ignored. The asterisk “*,” as will be discussed in more detail with reference to FIG. 5, represents a position in the log entry where otherwise similarly looking log entries differ. For example, the candidate state “authenticating on *” is created from the log entries “T4:authenticating on D2” and “T7:authenticating on D4.”

When the log entries 302a-302n are mapped to the candidate states 308a-308e, the sequence pattern 306 emerges. As shown in this example, the sequence patterns 306 may be intertwined. They may also branch. For example, if the log entry at timestamp T9 were “T9:not authenticated,” one exemplary sequence pattern 306 may include a member of the sequence having a branch to two possibilities: “authenticate” and “not authenticated.” This represents an exemplary possibility and depending on the frequency of appearance of such sequence patterns and/or other rules, two separate patterns may be proposed. In one example, the branched pattern mentioned above may be proposed; or only one of the two patterns may be considered (e.g., the “authenticated” pattern) while noting the occurrence of the other sequence pattern as a partially observed “authenticated” sequence where there was a missing entry. In the last case, the appearance of the “non-authenticated” log entry may be viewed entirely in isolation without any connection to the rest of the sequence pattern.

According to the procedure outlined above, the domain experts are engaged only after a substantial amount of data processing has already been performed. Provided this data pre-processing, the information about the data logs can be generated for the domain experts in various user-friendly forms including, but not limited to, tabular and visual forms that organize and present the data according to many criteria (e.g., provide spatial and temporal indexes and statistics information, including high-order correlations, regarding the log entry categories, the log entries themselves, or even the contents and the various fields found in the log entries). This allows the limited access that analysts have to domain experts to become productive as the former can ask very pointed questions about their ultimate objective (the process model) even when they do not understand the data logs from the outset. The domain experts can also provide their feedback using very specific representations of the model and hence provide pointed feedback as to how the model can be modified, simplified, or become more detailed, rather than spending time explaining the minute nuisances of information hidden in the large number (possibly in the thousands, or even millions) of lines of data logs provided to the analysts.

For example, having seen the sequence pattern 306 in FIG. 3, a domain expert may very quickly verify that indeed this represents a portion of the process model of interest. The domain expert may even add a comment that after logging in to the system, the first database access is to an authentication server and hence the server ID must be the same for the corresponding log entries as, for example, appears to also be implied by the data log 300. The domain expert may also note that the candidate state “initializing process 5” can be ignored, or point to certain states or log entries and comment that they do not pertain to the process of interest and they can be filtered out and ignored during the monitoring of the system.

Turning now to FIG. 4, an exemplary method for agnostically grouping data log entries as described with respect to process block 206 of FIG. 2 is shown in accordance with an exemplary embodiment. As can be appreciated in light of the disclosure, the order of operation within the method is not limited to the sequential execution as illustrated in FIG. 4, but may be performed in one or more varying orders as applicable and in accordance with the present disclosure. As can be appreciated, the process steps of the method can be implemented as one or computer program products, components, or modules.

In one example, as shown in FIG. 4, the categorization method relies on physical characteristics of the log entries. Specifically, the method may begin at 400. For each log entry at block 402, the log entry is tokenized at block 404. Tokenization involves splitting a string of characters according to any number of rules. One such rule can include splitting the string into individual characters. Another such rule can include splitting the string whenever a space appears. In the present example, the latter splitting rule is implemented. The tokens in the log entry are counted at block 406.

The log entry is added to a list (or bucket) based on the number (n) of tokens in the log entry at blocks 408-412 where B is defined as the collection of all buckets. If the current log entry is the first log entry with n tokens at block 408, then a new bucket Bn is created to store the current log entry and any subsequent log entries with n tokens at block 410. Otherwise the log entry is stored to an existing bucket Bn at block 412. Once each log entry is processed at 402, the method may end at 414.

Turning now to FIG. 5, an exemplary method for generating the categories of a the data logs as described with respect to process block 208 of FIG. 2 is shown in accordance with an exemplary embodiment. As can be appreciated in light of the disclosure, the order of operation within the method is not limited to the sequential execution as illustrated in FIG. 5, but may be performed in one or more varying orders as applicable and in accordance with the present disclosure. As can be appreciated, the process steps of the method can be implemented as one or computer program products, components, or modules.

In one example, the method may begin at 500. In this example, the method correlates log entries by making use of a distance function dist(x,y) that determines a distance between two character strings x and y to measure how close or how far apart the two strings are. An exemplary distance function for two tokenized character strings with the same number of tokens, like the log entries in bucket Bn, is a simple counter that counts the number of positions in the tokenized strings where the tokens are different. For example, ignoring the timestamp, for the log entries 302a-302n in FIG. 3, dist(“authenticating on D2”, “authenticating on D4”) is equal to one where the two strings differ in one token, the third token, while dist(“accessing database D2”, “authenticating on D2”) is equal to two, where the two strings differ in two tokens, the first token and the second token.

To create the categories, for each pair of log entries in each bucket at blocks 502 and 503, the corresponding distance is calculated 504. At block 506, the buckets Bn are partitioned into sub-buckets (Bn(1), Bn(2), . . . , Bn(Nn). Placed in each one of the sub-buckets are the log entries in Bn that have distances less than a threshold tn at block 508 (i.e., for all x and y in Bn(i), dist(x,y)≦tn). If Bn has only one log entry, then only one sub-bucket is created containing this single log entry (i.e., the bucket Bn and its sole sub-bucket Bn(1) coincide) with distance between log entries in the bucket set to 0 by definition (i.e., d(x,x)=0).

As can be appreciated, the number of sub-buckets Nn that hold the log entries in Bn is not known in advance, but is determined during the assignment of log entries in the sub-buckets. In one example, if for a log entry (x) in bucket Bn, there exists at least one log entry (y) in each of the currently created sub-buckets Bn(i) (i=1, . . . , m) for which the distance dist(x,y)>tn, a new sub-bucket Bn(m+1) is created to accommodate the log entry x. By convention, the first bucket Bn(1) is created to accommodate the very first log entry on the data log with n tokens. The threshold tn may be selected according to various criteria. For example the threshold tn may be chosen to be independent of the number of tokens n. Alternatively, the threshold tn may be chosen to depend on n, thus, allowing the maximum distance d(x,y) for log entries in a bucket Bn to depend on the number of tokens.

Once each bucket has been processed at 502, for each sub-bucket Bn(i) at block 510, a candidate (operational) state is created as a summary representing all the log entries in the sub-bucket at block 512. In one example, the candidate state is created by comparing the tokens in each successive position of the log entries (optionally, excluding the timestamp), i.e., comparing all the first tokens created, ten all the second tokens, and so on. The representative summary (i.e., the newly created candidate state) will have as its i-th token, the token in the i-th position of any of the log entries compared. Then all the tokens in that position in the log entries compared are identical. Otherwise, the representative summary will have as its i-th token, an asterisk “*”. By the definition of sub-buckets, the category representation for log entries in Bn will contain no more than tn asterisks. Once each bucket has been processed at 510, the method may end at 514.

According to an exemplary embodiment, the method described herein may be implemented by a system or computer program product. Therefore, portions or the entirety of the method may be executed as instructions in a processor of a computer system. Thus, the present invention may be implemented, in software, for example, as any suitable computer program. For example, a program in accordance with the present invention may be a computer program product causing a computer to execute the example method described herein.

The computer program product may include a computer-readable medium having computer program logic or code portions embodied thereon for enabling a processor of a computer apparatus to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

Further, such programs, when recorded on computer-readable storage media, may be readily stored and distributed. The storage medium, as it is read by a computer, may enable the method(s) disclosed herein, in accordance with an exemplary embodiment of the present invention.

While an exemplary embodiment has been described, it will be understood that those skilled in the art, both now and in the future, may make various improvements and enhancements which fall within the scope of the claims which follow. These claims should be construed to maintain the proper protection for the invention first described.

What is claimed is:

1. A method of analyzing log data related to a software application, the method comprising:
selectively collecting data log entries that are related to the application;
agnostically categorizing the data log entries; and
associating the categories of the data log entries with one or more operational states of a model.

2. The method of claim 1 wherein the selectively collecting comprises filtering out log entries that are not related to the application.

3. The method of claim 1 wherein the selectively collecting comprises selectively collecting log files and selectively collecting data log entries from the selected log files.

4. The method of claim 3 wherein the selectively collecting data log entries comprises merging the data log entries based on a timestamp of the data log entries.

5. The method of claim 4 further comprising normalizing the timestamp of the data log entries.

6. The method of claim 1 wherein the agnostically categorizing comprises tokenizing the one or more data log entries and grouping the data log entries based on a number of tokens.

7. The method of claim 6 wherein the agnostically categorizing further comprises: for each group of the data log entries, estimating a difference between the data log entries within the groups, and sub-grouping the data log entries of the group based on the difference.

8. The method of claim 7 wherein the agnostically categorizing further comprises performing a comparison between data log entries of the sub-groups.
